(19) United States
(12) Patent Application Publication
(10) Pub. No.: US 2005/0089087 A1
(43) Pub. Date: Apr. 28, 2005

(54) Signal detection method with high detection probability and low false alarm rate

(75) Inventors: Wen-Ho Sheen, Minsyong Township (TW); Chii-Horng Chen, Taichung City (TW); Chien-Huei Lin, Taichung City (TW); Hsin-Hsiung Fang, Anding Township (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: ADMtek Incorporated, Hsin-chu City (TW)

(21) Appl. No.: 10/808,888

(22) Filed: Mar. 25, 2004

(30) Foreign Application Priority Data
Oct. 27, 2003 (TW) 092129827

(51) Int. Cl. H04B 1/707; H04B 1/69

(52) U.S. Cl. 375/150

(57) ABSTRACT

A signal detection method with high detection probability and low false alarm rate is provided for spread spectrum communication systems. The method includes steps of a) receiving discrete-time input signal, b) converting the input signal into a correlator output signal with finite number of values, c) selecting a maximum value and a minimum value from the magnitude of values, respectively, d) dividing the maximum value by the minimum value for obtaining an enhanced peak value of the correlator output signal, and e) comparing the enhanced peak value of the correlator output signal with a predetermined threshold, wherein the input signal is detected as a spread spectrum signal if the enhanced peak value of the correlator output signal is greater than or equal to the predetermined threshold, whereas the input signal is not detected as a spread spectrum signal if the enhanced peak value of the correlator output signal is less than the predetermined threshold. Simulation results show that the proposed method outperforms the conventional method.

### FIELD OF THE INVENTION

This invention relates to a signal detection method with high detection probability and low false alarm rate for spread spectrum communication systems.

### BACKGROUND OF THE INVENTION

Spread spectrum communication systems are essential due to their highly anti-jamming capability. Through spreading the symbol rate information signal by spreading sequences, the bandwidth of the transmitted chip rate signal spectrum is significantly larger than that of symbol rate information signal. In light of the spectrum spreading, spread spectrum communication systems immune from the corruption of interferences such as narrow band interference caused by other communication systems. In IEEE standard 802.11b, which specifies direct sequence spread spectrum (DSSS) communication systems in wireless local access network (WLAN), Barker code of length eleven is used as a spreading sequence that has extremely good autocorrelation property. With this property, Barker code can be used for signal detection and synchronization of the 802.11b signal.

FIG. 1 shows a flow chart of a conventional signal detection method. Let b[n] be the Barker code sequence of length 11 and r[n]=r(t=nTs) be the discrete-time received signal, wherein r(t) is the continuous-time received signal and Ts is the chip period. Let e[n] be the output signal of the correlator 11 (matched filter) with input the discrete-time received signal r[n] given by

$$e [ n ] = {\sum }_{k = 0}^{10} b [ k ] * r [ n + k ] .$$

The correlator output signal e[n] can be used for 802.11b signal detection and synchronization.

If the incoming signal r[n] is an 802.11b signal, under the condition of high SNR (Signal to Noise Ratio) and short multipath channel, the magnitude |e[n]| of e[n] is nearly a periodic function with a relatively large maximum value due to spreading gain. FIG. 2 shows a schematic plot of the magnitude |e[n]| of the correlator output signal e[n]. However, as the incoming signal r[n] is not an 802.11b signal (such as interference or Gaussian noise), |e[n]| is no longer periodic and the amplitude thereof becomes relatively small. Thus, |e[n]| can be used to indicate whether the incoming signal is 802.11b spread spectrum signal or not.

For suppression of noise, the average signal eₐ[n] of magnitude of correlator output e[n] is employed instead:

$${e}_{a} [ n ] = {\sum }_{m = 1}^{L} \vert e [ n + ( m - 1 ) * 11 ] \vert , n = 0 , 1 , … , 10$$

where L is the number of signal to be averaged.

The conventional signal detection method utilizing the maximum value of eₐ[n] is now described as follows. First of all, the correlator output signal e[n] is generated by processing the discrete-time received signal r[n] using the correlator 11. Then, a normalization factor Eₐ of the signal e[n] is calculated through the following equation (step 12):

$${E}_{a} = \sqrt{{\sum }_{n = 0}^{10} {\vert {e}_{a} [ n ] \vert}^{2}}$$

Then, obtain the maximum value M of the averaged signal eₐ[n] (step 13) and the normalized peak value P (step 14) given by
P=M/Eₐ

Finally, the normalized peak value P is compared with a predetermined threshold η (step 15). If the normalized peak value P is greater than or equal to the predetermined threshold η, the discrete-time received signal r[n] is detected as 802.11b signal (step 16, 17). Whereas if the normalized peak value P is smaller than the predetermined threshold η, the discrete-time received signal is not detected as 802.11b signal (step 16, 18).

The value of normalization factor Eₐ of signal e [n] and the maximum value M thereof are closely dependent on the gain setting of automatic gain control (AGC). The normalization factor Eₐ is used to normalize the received discrete-time signal power making the ratio of M to Eₐ of small variation regardless of imperfect AGC gain setting.

In the above-mentioned conventional signal detection method, the performance, such as the detection probability and the false alarm rate, are closely dependent on the predetermined threshold η and the normalized peak value P of the average signal eₐ[n]. FIG. 3 shows a schematic plot of the probability density functions (pdf) of P as the incoming signal is 802.11b signal and Gaussian noise, respectively. Let Ps[k] and Pn[k] be the normalized peak values associated with the kth packets as the incoming signal is associated with 802.11b signal and Gaussian noise, respectively. As shown in FIG. 3, with the predetermined threshold η set to be the intersection point of the two pdfs, the detection probability and the false alarm rate are calculated by the areas of A and B, respectively. The smaller the predetermined threshold η is chosen, the larger the detection probability and the false alarm rate will be. Moreover, as the two pdfs are more separate from each other (the intersection area is smaller), a higher detection probability and a lower false alarm rate can be achieved simultaneously by choosing an appropriate value of the predetermined threshold η. However, multi-path effect and additive Gaussian noise may smooth the correlator output e[n] and thus lead to smaller normalized peak value Ps[k] which further leads to larger intersection area in FIG. 3. In this case, it is more difficult to achieve high detection probability and low false alarm rate simultaneously.

From the above description, the performance of conventional method is easily degraded by multi-path effect and noise. Development of a new detection criterion robust against multi-path effect and noise becomes an important topic. In order to improve the performance of the conventional method, we propose a signal detection method that can achieve high detection probability and low false alarm rate simultaneously. Moreover, the proposed signal detection method in the invention is simple and easily finds application in industry.

### SUMMARY OF THE INVENTION

One object of the present invention is to provide a signal detection method which obtains the maximum value and the minimum value of the magnitude of correlator output signal, obtain a enhanced peak value (ratio of the maximum value to the minimum value), and then compares the enhanced peak value with the predetermined threshold so as to judge whether the discrete-time received signal is an 802.11b spread spectrum signal or not.

Another object of the present invention is to provide a signal detection method with high detection probability and low false alarm rate.

In accordance with one aspect of the present invention, a signal detection method used in a spread spectrum communication system for detecting a spread spectrum signal includes steps of: a) receiving an input signal, b) converting the input signal into a correlator output signal with finite number of values, c) obtaining a maximum value and a minimum value from the magnitude of the values, d) dividing the maximum value by the minimum value for obtaining an enhanced peak value of the correlator signal output, and e) comparing the enhanced peak value of the correlator output signal with a predetermined threshold, wherein the input signal is detected as the spread spectrum signal if the enhanced peak value of the correlator output signal is greater than or equal to the predetermined threshold, whereas the input signal is not detected as the spread spectrum signal if the enhanced peak value of the correlator output signal is less than the predetermined threshold.

Preferably, the spread spectrum communication system is a direct sequence spread spectrum communication system.

Preferably, the input signal is a discrete-time received signal.

Preferably, the discrete-time received signal is an IEEE 802.11b signal.

Preferably, the input signal is converted into the correlator output signal by means of a correlator for performing the step b).

Preferably, the correlator includes a Barker code to be served as a spreading sequence.

In accordance with another aspect of the present invention, a signal detection method used in a spread spectrum communication system for detecting a spread spectrum signal, comprising steps of: a) receiving an input signal, b) converting the input signal into a correlator output signal with finite number of values, c) calculating a first sum of A absolute values which are larger than the other absolute values and a second sum of B absolute values which are smaller than the other absolute values, respectively, d) dividing the first sum by the second sum for obtaining a enhanced peak value of the correlator output signal, and e) comparing the enhanced peak value of the correlator output signal with a predetermined threshold, wherein the input signal is detected as the spread spectrum signal if the enhanced peak value of the correlator output signal is greater than or equal to the predetermined threshold, whereas the input signal is not detected as the spread spectrum signal if the enhanced peak value of the correlator output signal is smaller than the predetermined threshold.

Preferably, the spread spectrum communication system is a direct sequence spread spectrum communication system.

Preferably, the input signal is a discrete-time received signal.

Preferably, the discrete-time received signal is an IEEE 802.11b signal.

Preferably, the input signal is converted into the correlator output signal by means of a correlator for performing the step b).

Preferably, the correlator includes a Barker code to be served as a spreading sequence.

Preferably, both A and B are greater than or equal to 1.

The above objects and advantages of the present invention will become more apparent after reviewing the following detailed descriptions and accompanying drawings, in which:

### BRIEF DESCRIPTION OF THE DRAWINGS

FIG. 1 is a flow chart of the conventional signal detection method;

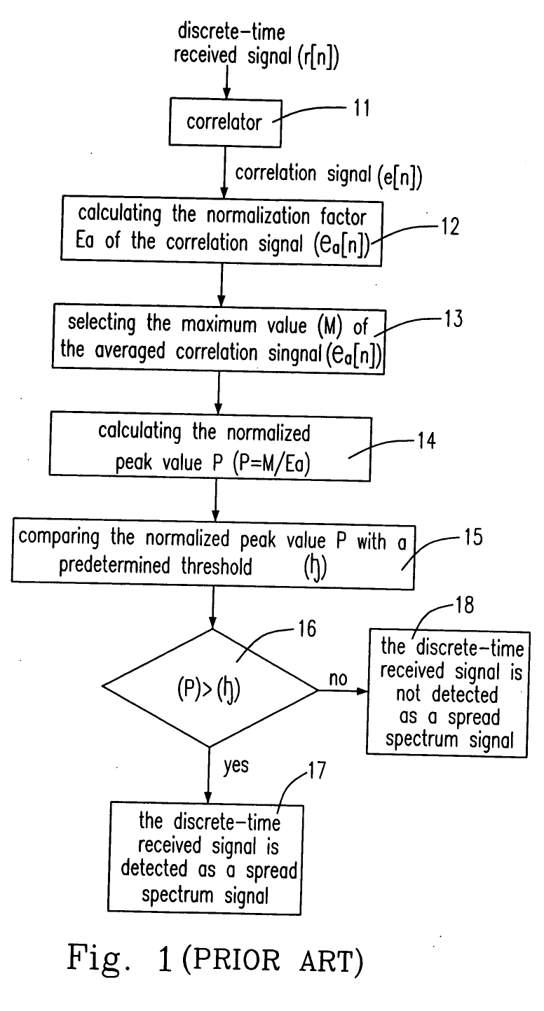

FIG. 2 is a schematic plot of the magnitude of the correlator output signal;

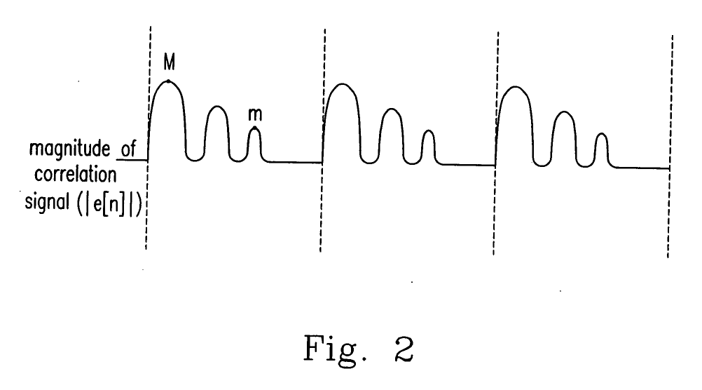

FIG. 3 is a schematic plot of the pdfs of the normalized peak values P associated with 802.11b signal and Gaussian noise for the conventional signal detection method;

FIG. 4 is a flow chart of a signal detection method according to a preferred embodiment of the present invention;

FIG. 5 is a schematic plot of the pdfs of the enhanced peak values associated with 802.11b signal and Gaussian noise for the proposed signal detection method according to a preferred embodiment of the present invention;

FIG. 6(a) is a simulation result of the pdfs of the normalized peak values associated with spread spectrum signal and Gaussian noise according to the conventional signal detection method; and

FIG. 6(b) is a simulation result of the pdfs of the enhanced peak values associated with spread spectrum signal and Gaussian noise obtained by the proposed signal detection method according to a preferred embodiment of the present invention.

### DETAILED DESCRIPTION OF THE PREFERRED EMBODIMENT

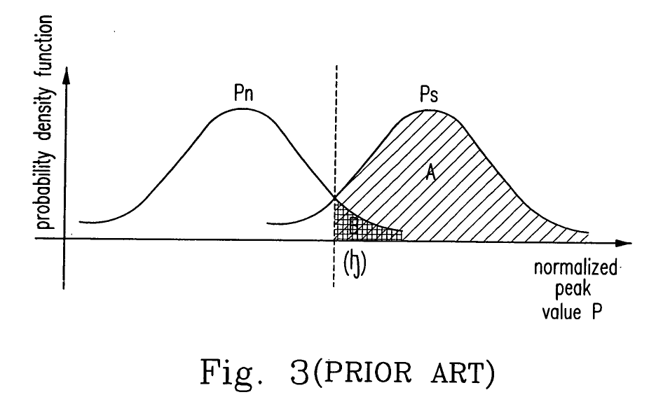

The present invention will now be described more specifically with reference to the following embodiments. For improving the conventional method, the present invention provides a novel signal detection method to significantly reduce the intersection area in FIG. 3 under the same conditions, and thus potentially achieve high detection rate and low false alarm rate simultaneously.

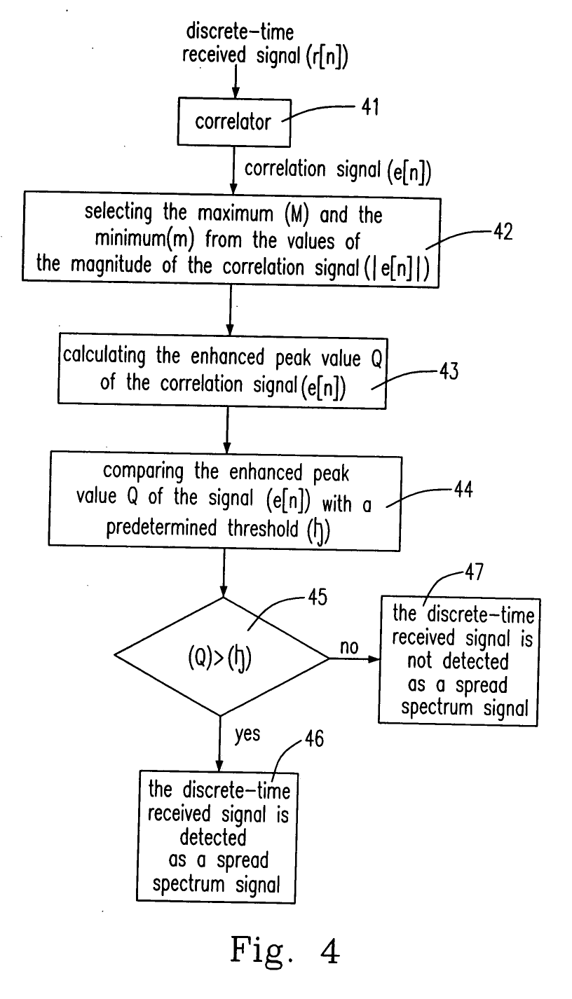

FIG. 4 shows a flow chart of a signal detection method according to a preferred embodiment of the present invention. The steps of the signal detection method according to the present invention are described as follows.

At first, correlator output signal e[n] with finite number of values is generated by processing the discrete-time received signal r[n] by means of a correlator 41. The discrete-time received signal r[n] can be an IEEE 802.11b signal, and the correlator includes a Barker code to be served as a spreading sequence. Then, obtain a maximum value (M) and a minimum value (m) from the magnitude of the correlator output signal e[n], respectively (step 42). Next, an enhanced peak value Q of the correlator output signal e[n] is calculated through dividing the maximum value of the magnitude of correlator output signal e[n] by the minimum value of the magnitude of correlator output signal e[n] (step 43). Finally, the enhanced peak value Q of the correlator output signal e[n] is compared with a predetermined threshold η (step 44). The discrete-time received signal r[n] is detected as a spread spectrum signal if the enhanced peak value Q of the correlator output signal e[n] is greater than or equal to the predetermined threshold η (step 45, 46), whereas the discrete-time received signal r[n] is not detected as a spread spectrum signal if the enhanced peak value Q of the correlator output signal e[n] is smaller than the predetermined threshold η (step 45, 47).

The above-mentioned signal detection method can be applied to all direct sequence spread spectrum communication systems. That is to say, the spread spectrum signal is not limited to IEEE 802.11b signal, and the spreading sequence is not limited to Barker code either. Furthermore, another preferred embodiment of the present invention with the employment of the sum of A absolute values which are larger than the other absolute values of the correlator output e[n] and the sum of B absolute values which are smaller than the other absolute values of the correlator output e[n] will be described as follows.

At first, the correlator output signal e[n] with finite number of values is generated by processing the discrete-time received signal r[n] by means of a correlator 41. The discrete-time received signal r[n] can be an IEEE 802.11b signal, and the correlator includes a Barker code to be served as a spreading sequence. Then, a first sum of A absolute values which are greater than the other absolute values of the correlator output e[n] and a second sum of B absolute values which are smaller than the other absolute values of the correlator output e[n] are calculated, respectively. Next, an enhanced peak value Q of the correlator output signal e[n] is calculated through dividing the first sum by the second sum. Finally, the enhanced peak value Q of the correlator output signal e[n] is compared with a predetermined threshold η. The discrete-time received signal r[n] is detected as a spread spectrum signal if the enhanced peak value Q of the correlator output signal e[n] is greater than or equal to the predetermined threshold η, whereas the discrete-time received signal r[n] is not detected as a spread spectrum signal if the enhanced peak value Q of the correlator output signal e[n] is smaller than the predetermined threshold η.

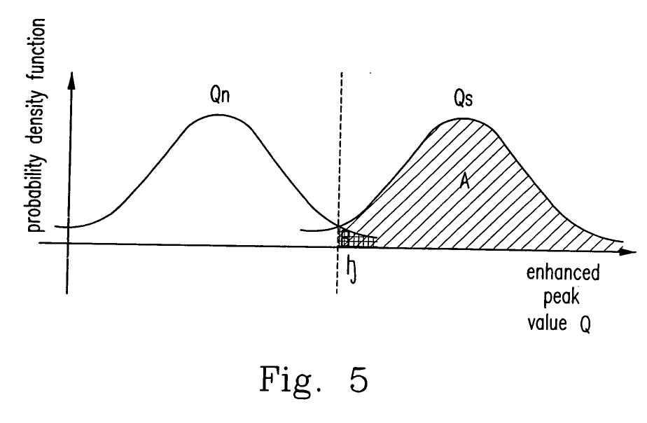

The present invention is to employ the maximum value and the minimum value of the magnitude of the correlator output signal e[n] to calculate the enhanced peak value Q of the correlator output signal e[n], and then to compare the enhanced peak value Q with the predetermined threshold η so as to judge whether the discrete-time received signal r[n] is a spread spectrum signal or not. FIG. 5 shows a schematic plot of the pdfs of the enhanced peak value associated with 802.11b signal and Gaussian noise for the signal detection method according to a preferred embodiment of the present invention. Let Qs[k] and Qn[k] be the enhanced peak value Q associated with the kth packet as the incoming signal is 802.11b signal and Gaussian noise, respectively. As shown in FIG. 5, under the same environment setting, the two pdfs of Qs[k] and Qn[k] are more separate than those of Ps[k] and Pn[k] for the conventional signal detection method in FIG. 3. Therefore, with an appropriate choice of the predetermined threshold η, higher detection probability and lower false alarm rate can be achieved simultaneously.

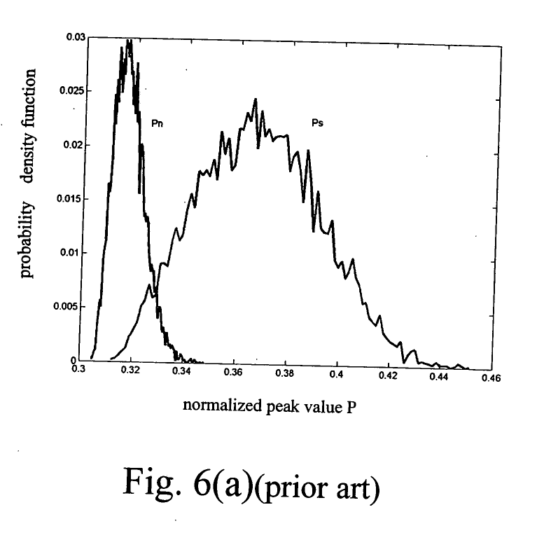

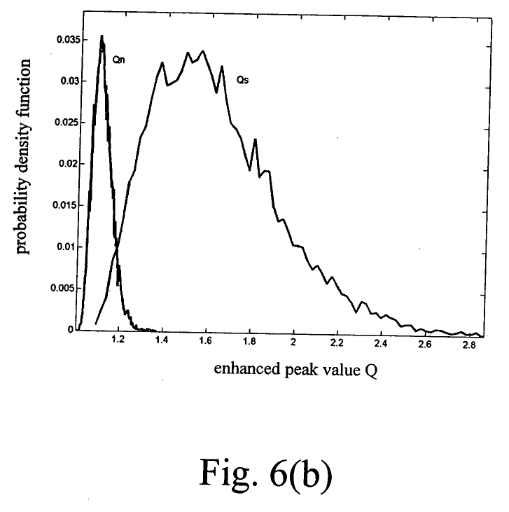

Please refer to FIG. 6(a) and FIG. 6(b). FIG. 6(a) shows a simulation result of the pdfs of the normalized peak values P associated with a spread spectrum signal and Gaussian noise according to the conventional signal detection method, and FIG. 6(b) shows a simulation result of the pdfs of the enhanced peak value Q associated with the same spread spectrum signal and Gaussian noise obtained by the signal detection method according to a preferred embodiment of the present invention. The received spread spectrum signal is output of a multi-path channel contaminated by Gaussian noise with input a spread spectrum signal generated by spreading the quadrature amplitude modulation (QAM) signal with Barker code. The multi-path channel is generated according to the IEEE exponentially delay profile. The results in FIGS. 6(a) and 6(b) are the pdfs of P for conventional method and Q for the proposed method, respectively, calculated from 10,000 independent realizations. As shown in FIGS. 6(a) and 6(b), the intersection area of the pdfs associated with the spread spectrum signal and noise is smaller for the proposed method than the conventional method. Let us choose the predetermined threshold η as 0.3325 and 1.2294 for the conventional method and proposed method, respectively. Note these two thresholds are very close to the intersection of Ps and Pn and the intersection of Qs and Qn, respectively. Then the detection probability and the false alarm rate of the conventional signal detection method are 0.9389 and 0.0234 respectively, whereas the detection probability and the false alarm rate according to the present invention are 0.9607 and 0.0210, respectively. The proposed method performs better than the conventional method with a higher detection probability and a lower false alarm rate.

In view of the aforesaid description, the present invention employs the maximum value and the minimum value of the magnitude of the correlator output signal to calculate an enhanced peak value of the correlator output signal, and then compares the enhanced peak value with the predetermined threshold so as to judge whether the discrete-time received signal is a spread spectrum signal or not. Through utilizing the signal detection method of the present invention, high detection probability and low false alarm rate can be achieved. Accordingly, the signal detection method in the present invention improves the prior art and is expected to be widely used in industry.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A signal detection method used in a spread spectrum communication system for detecting a spread spectrum signal, comprising steps of:
a) receiving an input signal;
b) converting said input signal into a correlator output signal with finite number of values;
c) selecting a maximum value and a minimum value from the magnitude of said values respectively;
d) dividing said maximum value of magnitude of said values by said minimum value of magnitude of said values for obtaining an enhanced peak value of said correlator output signal; and
e) comparing said enhanced peak value of said correlator output signal with a predetermined threshold, wherein said input signal is detected as said spread spectrum signal if said enhanced peak value of said correlator output signal is one of larger than and equal to said predetermined threshold, whereas said input signal is not detected as said spread spectrum signal if said enhanced peak value of said correlator output signal is smaller than said predetermined threshold.

2. The method as claimed in claim 1, wherein said spread spectrum communication system is a direct sequence spread spectrum communication system.

3. The method as claimed in claim 1, wherein said input signal is a discrete-time received signal.

4. The method as claimed in claim 3, wherein said discrete-time received signal is an IEEE 802.11b signal.

5. The method as claimed in claim 1, wherein said input signal is converted into said correlator output signal by means of said correlator for performing said step b).

6. The method as claimed in claim 5, wherein said correlator includes a Barker code to be served as a spreading sequence.

7. A signal detection method used in a spread spectrum communication system for detecting a spread spectrum signal, comprising steps of:
a) receiving an input signal;
b) converting said input signal into a correlator output signal with finite number of values;
c) calculating a first sum of A absolute values which are larger than the other absolute values of said correlator output signal and a second sum of B absolute values which are smaller than the other absolute values of said correlator output signal, respectively;
d) dividing said first sum by said second sum for obtaining an enhanced peak value of said correlator output signal; and
e) comparing said enhanced peak value of said correlator output signal with a predetermined threshold, wherein said input signal is detected as said spread spectrum signal if said enhanced peak value of said correlator output signal is one of greater than and equal to said predetermined threshold, whereas said input signal is not detected as said spread spectrum signal if said enhanced peak value of said correlator output signal is less than said predetermined threshold.

8. The method as claimed in claim 7, wherein said spread spectrum communication system is a direct sequence spread spectrum communication system.

9. The method as claimed in claim 7, wherein said input signal is a discrete-time received signal.

10. The method as claimed in claim 9, wherein said discrete-time received signal is an IEEE 802.11b signal.

11. The method as claimed in claim 7, wherein said input signal is converted into said correlator output signal by means of said correlator for performing said step b).

12. The method as claimed in claim 11, wherein said correlator includes a Barker code to be served as a spreading sequence.

13. The method as claimed in claim 7, wherein both said A and said B are one of greater than and equal to 1.
